(19) United States
(12) Patent Application Publication
(10) Pub. No.: US 2011/0295681 A1
(43) Pub. Date: Dec. 1, 2011

(54) METHOD AND SYSTEM FOR CONTENT AND APPLICATION SERVING MECHANISM

(76) Inventors: Roop Kumar Bhadury, Eastern Heights (AU); Derek McDonald, Jimboomba (AU); Dev Mayur Zaveri, Robertson (AU)

(21) Appl. No.: 13/117,027

(22) Filed: May 26, 2011

Related U.S. Application Data
(60) Provisional application No. 61/348,569, filed on May 26, 2010.

(51) Int. Cl. G06Q 30/00

(52) U.S. Cl. 705/14.48; 705/14.73

(57) ABSTRACT

A method and system for content and application serving mechanism is disclosed. According to one embodiment, a tiered campaign is created that contains a plurality of advertisements. The plurality of advertisements is served in one or more sections of a web browser. Each of the assignments is assigned with a priority and preferences and served to the web browser based on the assigned preferences and priorities.

The present application claims the benefit of the earlier filing date of U.S. Provisional Patent Application No. 61/348,569 entitled “Content and Application Serving Mechanism” and filed on May 26, 2010, which is hereby incorporated by reference in its entirety.

### FIELD

The field of the invention relates generally to online advertising and content delivery systems and methods of providing such advertisements and content via online media. In particular, the present method and system is directed to content and application serving mechanism in a tiered structure.

### BACKGROUND

Online advertisers provide various ways to increase website traffic and visitors for promoting sales on websites. The currently available web advertising and tracking mechanisms such as pay-per-click, pay-per-impression, pay-per-join, pay-per-email, help online advertisers to promote their services or products. Publishers hosting such web sites collect fees based on their trafficking performance.

Typical online advertisements appearing on a web browser or an application running on an electronic device (e.g., smart phone, tablet PC, set-top box) display previously created content. Such content is programmed to be streamed to the web browser or the applications. For providing such content, content servers embed a specific code to web pages published by a publisher and sponsored by online advertisers. As more sophisticated content delivery and serving schemes develop, the embedding of codes to numerous pages and linking to online advertiser's content server, and the control and management of content embedding and linking becomes vastly complex and inefficient.

The present invention overcomes the above-identified shortcoming of prior art content serving techniques and provides benefits and solutions for efficient delivery, control, and management of content and applications.

### OBJECTIVES AND SUMMARY

A method and system for content and application serving mechanism is disclosed. According to one embodiment, a tiered campaign is created that contains a plurality of advertisements. The plurality of advertisements is served in one or more sections of a web browser. Each of the assignments is assigned with a priority and preferences and served to the web browser based on the assigned preferences and priorities.

It is an objective of the present invention to provide a light-weight code to serve an ad campaign containing multiple advertisements. The preferences for a campaign are saved while creating the ads and content in the campaign. From an inventory management perspective, it is advantageous to allow users to specify ad preferences before the campaign is fully implemented and served. One the preferences are saved, other fluid content can be served without changing the configuration of the campaign once the campaign is created.

The above and other preferred features, including various novel details of implementation and combination of elements, will now be more particularly described with reference to the accompanying drawings and pointed out in the claims. It will be understood that the particular methods and circuits described herein are shown by way of illustration only and not as limitations. As will be understood by those skilled in the art, the principles and features described herein may be employed in various and numerous embodiments without departing from the scope of the invention.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates a flow chart of an exemplary ad and content serving mechanism, according to one embodiment;

FIGS. 2A-2C illustrate a flow chart of an exemplary ad distribution process, according to one embodiment;

FIGS. 3A-3B illustrate a flow chart of an exemplary campaign creation process, according to one embodiment; and

FIG. 4 illustrates an exemplary computer architecture for use with the present system, according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A method and system for content and application serving mechanism is disclosed. According to one embodiment, a tiered campaign is created that contains a plurality of advertisements. The plurality of advertisements is served in one or more sections of a web browser. Each of the assignments is assigned with a priority and preferences and served to the web browser based on the assigned preferences and priorities.

The present application is related to U.S. patent application entitled “End User Viewable Web Element” by Roop Kumar Bhadbury and Dev Mayur Zaveri, filed on May 26, 2011; U.S. patent application entitled “Advertising and Mobile Site Builder” by Roop Kumar Bhadbury, Mark Brown, Derek McDonald, and Dev Mayur Zaveri, filed on May 26, 2011; and U.S. patent application entitled “User Account Linking” by Roop Kumar Bhadbury, Derek McDonald, and Dev Mayur Zaveri, filed on May 26, 2011, the entire contents of which are incorporated herein by reference.

Each of the features and teachings disclosed herein can be utilized separately or in conjunction with other features and teachings to provide a method and system for providing asynchronous data communication in a networked environment. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense, and are instead taught merely to describe particularly representative examples of the present teachings.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

Some terms are defined below in alphabetical order for easy reference. These terms are not rigidly restricted to these definitions. A term may be further defined by its use in other sections of this description.

“Ad/advertisement” means a commercial message targeted to an advertiser's customer or prospect.

“Ad banner” means a graphical image or other type of media object used as an advertisement.

“Ad impression” means 1) an advertisement that is served to a user's browser. Ads can be requested by the user's browser (also referred to as pulled ads) or they can be pushed, such as email ads; 2) a measurement of responses from an ad delivery system to an ad request from the user's browser that is filtered from robotic activity and is recorded at a point as late as possible in the process of delivery of the creative material to the user's browser.

“Database” means a collection of data organized in such a way that a computer program may quickly select desired pieces of the data. A database is an electronic filing system. In some implementations, the term “database” may be used as shorthand for “database management system”.

“Device” means software, hardware or a combination thereof. A device may sometimes be referred to as an apparatus. Examples of a device include without limitation a software application such as Microsoft Word®, a laptop computer, a database, a server, a display, a computer mouse, a mobile device, a tablet device and a hard disk. Each device is configured to carry out one or more steps of the method of storing an internal identifier in metadata.

“Link” means an association with an object or an element in memory. A link is typically a pointer. A pointer is a variable that contains the address of a location in memory. The location is the starting point of an allocated object, such as an object or value type, or the element of an array. The memory may be located on a database or a database system. “Linking” means associating with (e.g., pointing to) an object in memory.

“Microsite/micro website” generally means a website containing an individual web page or a small cluster pages mean to function as an auxiliary supplement to a primary website. Often, microsites are used for editorial purposes by a commercial business to add editorial value. Microsites may be used for purely commercial purposes to create in-depth information about a particular product, service or as editorial support towards a specific product, such as describing a new technology.

“Metadata” generally means data that describes data. More particularly, metadata may be used to describe the contents of digital recordings. Such metadata may include, for example, a track name, a song name, artist information (e.g., name, birth date, discography), album information (e.g., album title, review, track listing, sound samples), relational information (e.g., similar artists and albums, genre) and/or other types of supplemental information. Conventional optical discs (e.g., CDs, DVDs, Blu-ray Discs) do not typically contain metadata. Metadata may be associated with a digital recording (e.g., song, album, movie or video) after the digital recording has been ripped from an optical disc, converted to another digital audio format and stored on a hard drive.

“Network” means a connection between any two or more computers, which permits the transmission of data. A network may be any combination of networks, including without limitation the Internet, a local area network, a wide area network, a wireless network and a cellular network.

“Server” means a software application that provides services to other computer programs (and their users), in the same or other computer. A server may also refer to the physical computer that has been set aside to run a specific server application. For example, when the software Apache HTTP Server is used as the web server for a company's website, the computer running Apache is also called the web server. Server applications can be divided among server computers over an extreme range, depending upon the workload.

“Software” means a computer program that is written in a programming language that may be used by one of ordinary skill in the art. The programming language chosen should be compatible with the computer by which the software application is to be executed and, in particular, with the operating system of that computer. Examples of suitable programming languages include without limitation Object Pascal, C, C++ and Java. Further, the functions of some embodiments, when described as a series of steps for a method, could be implemented as a series of software instructions for being operated by a processor, such that the embodiments could be implemented as software, hardware, or a combination thereof. Computer readable media are discussed in more detail in a separate section below.

“System” means a device or multiple coupled devices. A device is defined above.

“User” means a consumer, client, and/or client device in a marketplace of products and/or services.

“User device” (e.g., “client”, “client device”, “user computer”) is a hardware system, a software operating system and/or one or more software application programs. A user device may refer to a single computer or to a network of interacting computers. A user device may be the client part of a client-server architecture. A user device typically relies on a server to perform some operations. Examples of a user device include without limitation a CD player, a DVD player, a Blu-ray Disc player, a personal media device, a portable media player, an iPod®, a Zoom Player, a laptop computer, a palmtop computer, a smart phone, a cell phone, a mobile phone, an mp3 player, a digital audio recorder, a digital video recorder, an IBM-type personal computer (PC) having an operating system such as Microsoft Windows®, an Apple® computer having an operating system such as MAC-OS, hardware having a JAVA-OS operating system, and a Sun Microsystems Workstation having a UNIX operating system.

“Web browser” means any software program which can display text, graphics, or both, from Web pages on Web sites. Examples of a Web browser include without limitation Mozilla Firefox® and Microsoft Internet Explorer®.

“Web page” means any documents written in mark-up language including without limitation HTML (hypertext mark-up language) or VRML (virtual reality modeling language), dynamic HTML, XML (extended mark-up language) or related computer languages thereof, as well as to any collection of such documents reachable through one specific Internet address or at one specific Web site, or any document obtainable through a particular URL (Uniform Resource Locator).

“Web server” refers to a computer or other electronic device which is capable of serving at least one Web page to a Web browser. An example of a Web server is a Yahoo® Web server.

“Web site” means at least one Web page, and more commonly a plurality of Web pages, virtually coupled to form a coherent group.

The various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present method and system is directed to an advertisement server (Ad Server) that serves content, ads, applications, or any other type of information, to micro-websites, mobile applications, and mini web applications (e.g., widgets) as well as more general advertising content delivery mechanisms such as banner ads, towers, skyscrapers, video ads, overlays and interstitials, among others. In one embodiment, Ad Server functions as a ‘back-end’ server controlling and managing the delivery of content, applications, campaigns, and reporting and inventory management. The elements and various embodiments of the present invention are described hereinafter.

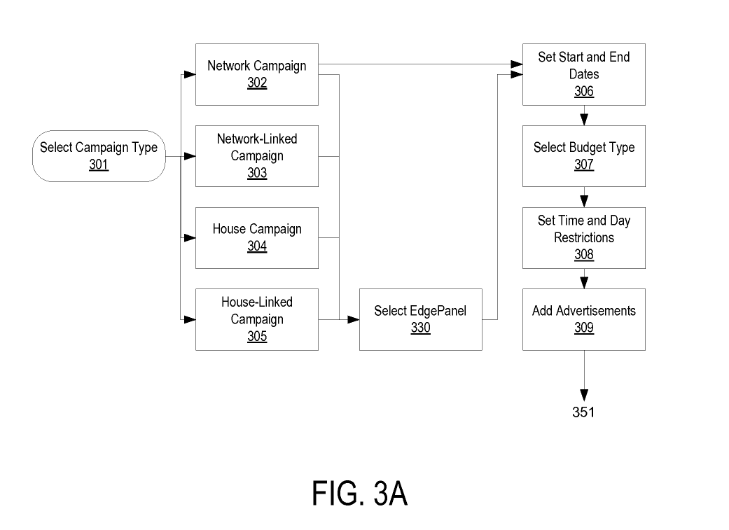

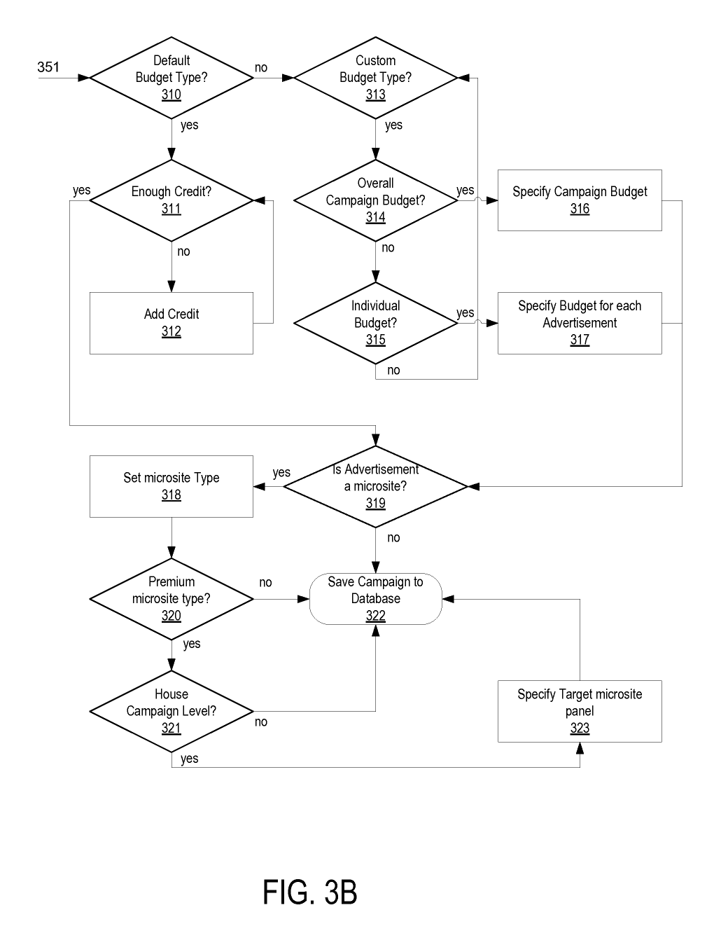

FIGS. 3A and 3B illustrate a flow chart of an exemplary campaign creation process, according to one embodiment. A user (also referred to as client) chooses a type of campaign (step 301) using a campaign creation interface that the present content and ad serving system provides. There are various types of campaigns to choose from. For example, House campaign 304 and House-linked campaign 305 cater to self-advertising of content management needs while Network campaign 302 and Network-Linked campaign 303 are intended for external advertising and content targeting website and/or application users. Internal advertising refers to the practice by web publishers of maintaining and presenting their own ads and content, or directly controlling the displayed ads or content on their own websites. External advertising typically refers to ads being delivered and managed by external advertisers and content providers, not by the web publisher. The Ad Server allows for management of such internal ads and content as well as external ads and content.

According to one embodiment, the present content and application serving mechanism employs a layered, self-positioning panel (also referred to as Panel herein) providing a user viewable element in a web browser served by Ad Server. This lightweight Panel is added to a web page by inserting a small snippet of code in the HTML of the web page. The Panel can be specifically targeted for a campaign-creating user while the user creates the campaign. In one embodiment, the created campaign may be any combination of House or Network campaigns 302-305 available from Ad Server.

The user specifies the start date and end date (step 306), a budget type (step 307), and set time and restrictions (step 308) for the selected campaign during the campaign creation process. According to one embodiment, the budget type is selected from two options, i.e., default type 310 and custom type 313. By default, the user does not specify a budget amount and the campaign will be active until their credit runs out (or reaches the minimum predetermined amount) (step 311). If the credits are not available, the user is asked to add credit to continue to use the ad serving system (step 312).

In the custom option, the user can choose to have either a campaign level budget (steps 314 and 316) or an advertisement level budget (steps 315 and 317). After the type and budget of the campaign is chosen, it is determined whether the ad will display on a microsite (step 319). The type, priority and exposure level of the microsite is determined (steps 318, 320, and 321), and the results are saved to database (step 322). If any House ads are found, the targeted microsite panel is specified (step 323) and saved to database (step 322). In one embodiment, the microsite is separately treated by the Ad Server owing to the layered nature of the format. In this case, the microsite is treated as multiple separate interactive elements that are aggregated, analyzed and reported on. All other ad formats like banners, widgets etc. can either be displayed separately as part of a microsite. In other words, one can view the microsite format as a ‘super ad’ that contains multiple interactive ad elements and formats, otherwise only partially evident in individual ad formats.

According to one embodiment, the user campaigns created using the present content and application serving mechanism have a tiered structure. During the creation of a single campaign, a user can select one or more microsites as well as one or more banners or other types of media ads. Ad impressions can be booked at an element level in each individual ad on the user's browser and scheduled along with other advertisements in the campaign.

In one embodiment, each ad is created as an individual campaign at Ad Server. This allows for fine-grained control of ad serving. This level of ad management allows for ad impressions to be booked in increments of as low as one ad impression.

According to one embodiment, ads, content and/or applications are created and preferences are saved while creating a campaign. This is different from typical Ad Servers in which inventory creation is tied to campaign creation, i.e., when a new campaign is created, the inventory is also created. Once the campaign is created, the inventory cannot be dynamically served, and when a new inventory is required, a new campaign must be created. Users can specify ad preferences like geo-targeting and keyword targeting before the campaign is fully implemented and served.

According to one embodiment, Ad Server allows publishers to target specific sections of their website with specific ads in a campaign. For example, publishers can specifically target three panels within the ad-viewing area of Panel. Publishers can specify which ads appear on their panels and in which order. Since the Panel displays timed ads, controls the order of ads, publishers are allowed to price the second ad lower than the first ad, for instance. Publishers can also display a mix of ads as well as non-commercial internal content and manipulate the order of the displays, for example, showing a contact form initially, followed by an ad subsequently. These panels may be dynamically repositioned and updated as the ad timer expires or the user switches to a new website. These panels also provide the publisher an enhanced layer of controlled and targeted ad content management and serving. The present content control and serving mechanism may be extended to other applications and online media that are selectable by the publishers on their website.

According to one embodiment, Ad Server has built-in weights attached to different ad and content types. The built-in weights determine ad/content display priorities. For example, content that is marked as ‘House’ (for internal serving by publishers) is given the highest priority by Ad Server, followed by ads marked with ‘Premium’, ‘Regular’, ‘Internal’ (for filler content) and other ad serving applications such as Google AdSense. Different ad formats from multiple networks can also be served with separately specified priorities based on the built-in weight.

According to one embodiment, a server-side installable module is provided to handle the displayed content and ad serving. The displayed content and ads are synchronized with Ad Server. This server-side installable module is lean such that a separate installation of the module is not required or at least transparent to the user. This server-side installable mechanism significantly improves the efficiency and speed of the ad serving compared to conventional ad serving mechanisms.

According to one embodiment, a web server add-on is provided to extend the core capability of Ad Server by adding a parallel content serving capability. This server-side add-on is extends the Apache style web server in that parallel content serving is provided. The add-on module allows a unique distributed ad serving capability that works in conjunction with the web server. The add-on module also sources and serves content in conjunction with the hosting web server. The web server add-on contains an embedded multithreading ‘light’ web server dedicated to serving ad content. The embedded web server operates in conjunction with N ‘light’ embedded database and caches to ensure efficient content and application serving.

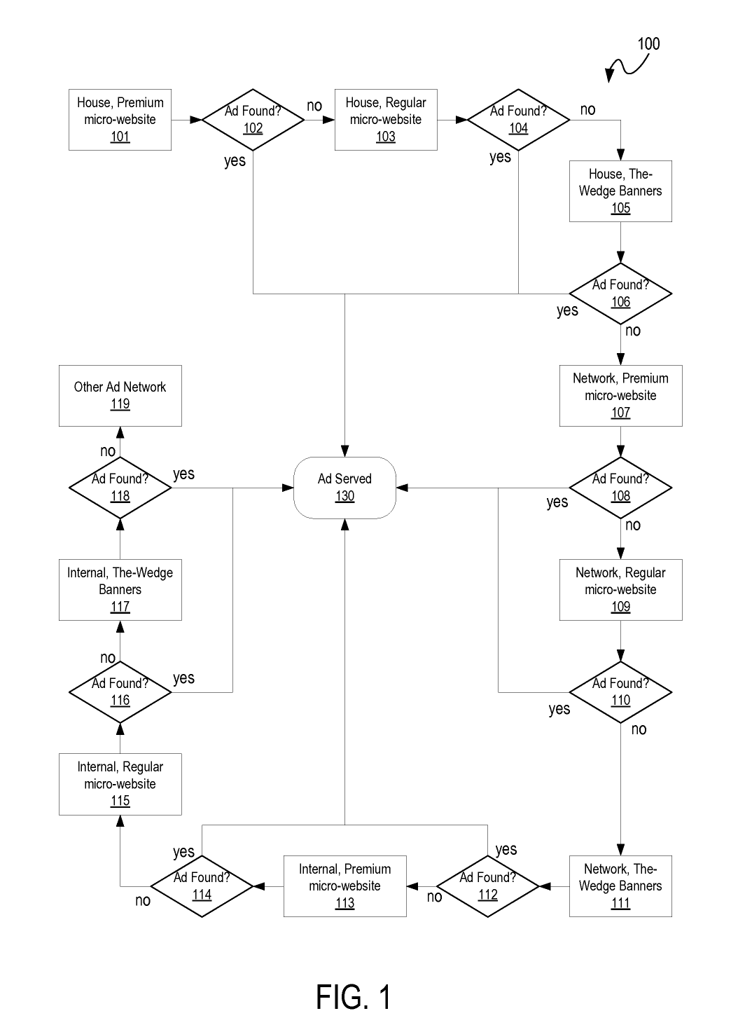

FIG. 1 illustrates a flow chart of an exemplary ad serving mechanism, according to one embodiment of the present invention. House ads and content are defined as content that the publisher is direct placing on their own websites. Premium ads and content have greater exposure duration than Regular ads, in addition to additional functional capabilities.

According to one embodiment, content priority and level of exposure determines the ad serving and distribution process. For example, House and Premium ads 101 are served with the highest priority. If it is not found, the next highest priority ads, i.e., House and Regular ads 103, House and Banner ads 105 are served in sequence. After all House ads are consumed, Network ads 107, 109, and 111 are served in the order of exposure priority (Premium, Regular, and Banner). Similarly, after all House and Network ads are consumed, Internal ads 113, 115, and 117 are served in the same exposure priority. Finally, after all House, Network, and Internal ads are consumed, other ad network ads 119 are served.

According to one embodiment, the Panel within user's browser requests advertising and content within its multiple layers. The ad provided by Ad Server is updated when a particular layer within the web panel is made active.

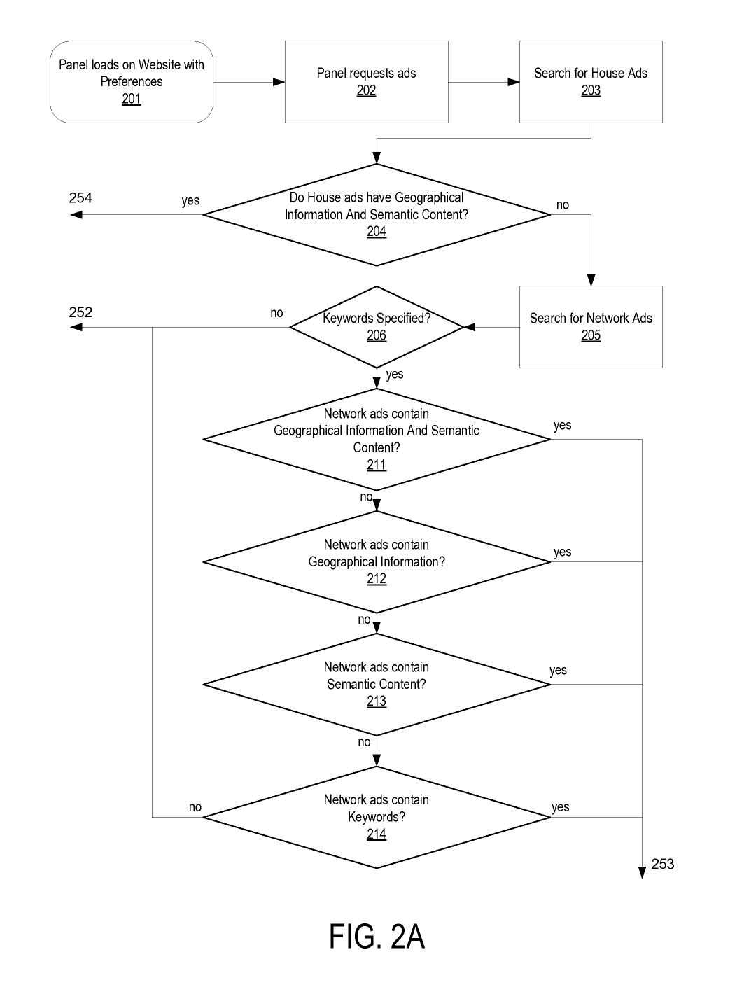

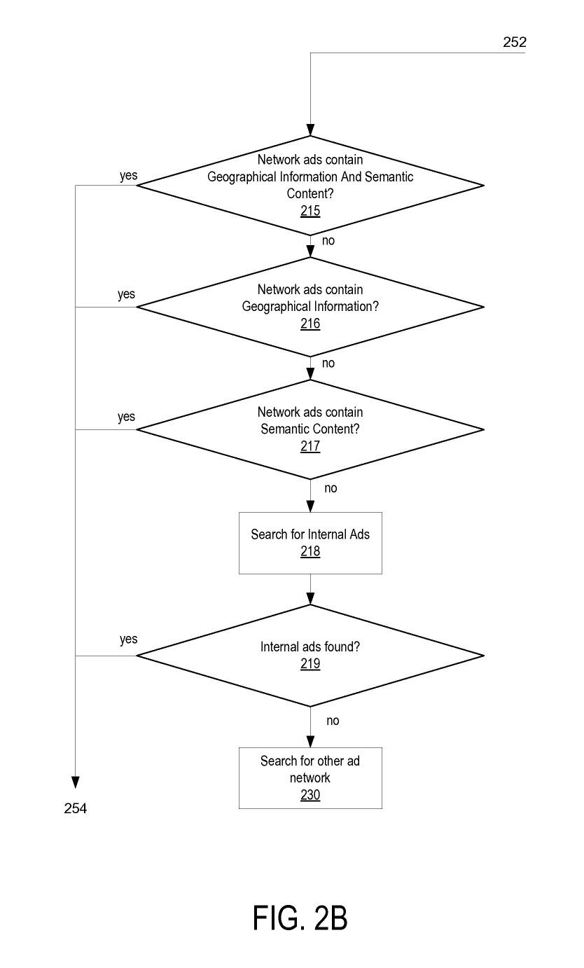

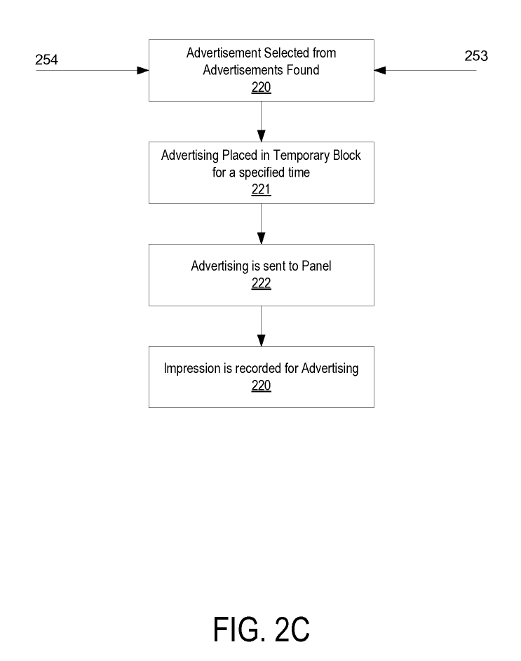

FIGS. 2A-2C illustrate a flow chart of an exemplary ad distribution process, according to one embodiment of the present invention. FIGS. 2A through to 2C describe a decision system of the Ad server that determines which ads are to be shown and consequently what data is to be recorded. The Panel loads on a website with preferences (step 201). After being loaded, the Panel requests ads (step 202). Each ad has attributes such as priority, the number of layers or pages, the number of clickable areas, video content presence/absence, forms, surveys, ecommerce etc. The highest priority ads, i.e., House ads, are first searched for (step 203). The House ads found during the search are prioritized based on secondary attributes (e.g., exposure time) (step 220), placed in a temporary block for a specified time (step 221), and sent to the Panel (step 222). An ad impression created from the selected ads and is recorded in the user's browser (step 220).

If no House ad is found, the next highest priority ads, i.e., Network ads, are searched for (step 205). The ads are checked whether they contain any specific keyword such as geographically information, semantic content, etc. The Network ads found are checked whether they contain other keywords (steps 211-217). After all the House and Network ads are consumed, Internal ads are searched for (step 218) and then a search is conducted for other ad networks (step 230). The searched ads are prioritized (step 220), placed in a temporary block for a specified time (step 221), and sent to the Panel (step 222). An ad impression created from the selected ads and is recorded in the user's browser (step 220).

According to one embodiment, the present ad and content serving mechanism allows fine-grained ad impression management allowing for the management of ads at an individual ad level. For example, one can serve x number impressions of ads of Ad A and y number of impressions of Ad B within the same campaign. Additionally, specific ads can be served based on a specific time of a day or multi-zone targeting is possible. Multi-zone targeting refers to a situation where different campaigns display ads on different timed panels on the same webpage. Within this as well, different ads can be displayed with differing day-part attributes. Publishers can choose to say, direct control ad display on one timed panel and let network ads show on the remaining timed panels.

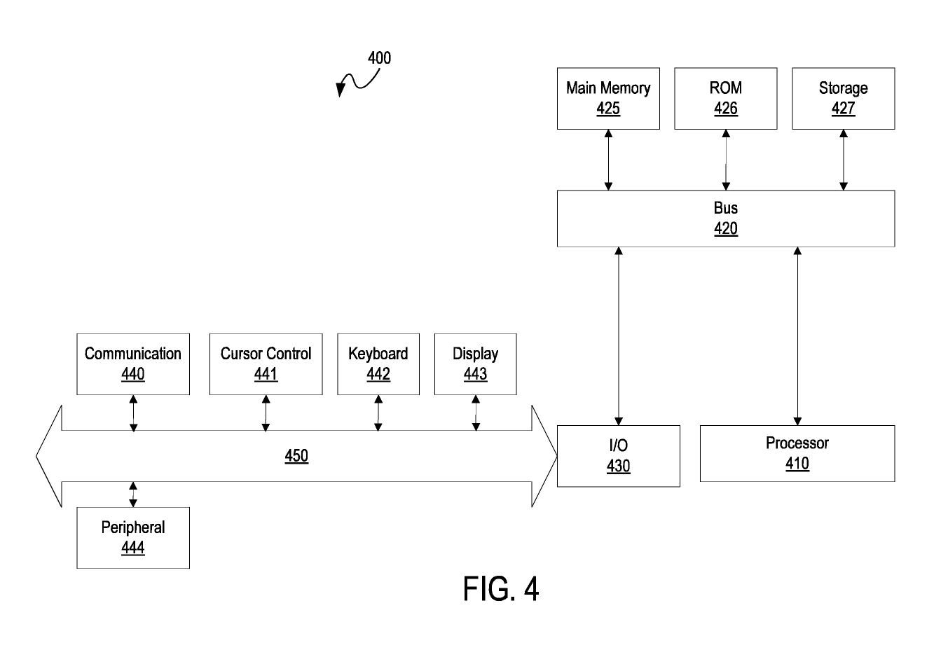

FIG. 4 illustrates an exemplary computer architecture 400 for use with the present system, according to one embodiment. The computer architecture 400 may be used to implement the present ad serving system. One embodiment of the architecture 400 comprises a system bus 420 for communicating information, and a processor 410 coupled to the bus 420 for processing information. The architecture 400 further comprises a random access memory (RAM) or other dynamic storage device 425 (referred to herein as main memory), coupled to the bus 420 for storing information and instructions to be executed by the processor 410. Main memory 425 also may be used for storing temporary variables or other intermediate information during execution of instructions by the processor 410. The architecture 400 also may include a read only memory (ROM) and/or other static storage device 426 coupled to the bus 420 for storing static information and instructions used by the processor 410.

A data storage device 427 such as a flash memory, a magnetic disk or optical disc and its corresponding drive may also be coupled to the computer system architecture 400 for storing information and instructions. The architecture 400 can also be coupled to a second I/O bus 450 via an I/O interface 430. A plurality of I/O devices may be coupled to the I/O bus 450, including a display device 443, an input device (e.g., an alphanumeric input device 442 and/or a cursor control device 441).

The communication device 440 allows for access to other computers (servers or clients) via a network. The communication device 440 may comprise a modem, a network interface card, a wireless network interface or other well known interface device, such as those used for coupling to Ethernet, token ring, or other types of networks.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments of the invention also relate to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A method and system for content and application serving system and method has been described. It is understood that the embodiments described herein are for the purpose of elucidation and should not be considered limiting the subject matter of the disclosure. Various modifications, uses, substitutions, combinations, improvements, methods of productions without departing from the scope or spirit of the present invention would be evident to a person skilled in the art.

We claim:

1. A computer-implemented method, comprising:
creating a tiered campaign containing a plurality of advertisements in one or more sections of a viewing window;
assigning a priority and preferences to each of the plurality of advertisements; and
serving the plurality of advertisements based on the assigned preferences and priorities.

2. The computer-implemented method of claim 1, wherein the priority comprises a display priority and exposure priority.

3. The computer-implemented method of claim 2, wherein the display priority comprises House priority, Network priority, Internal priority, and external priority.

4. The computer-implemented method of claim 3, wherein the plurality of advertisements are served in the order of House priority, Network priority, Internal priority, and external priority.

5. The computer-implemented method of claim 1 further comprising assigning a campaign type to the tiered campaign.

6. The computer-implemented method of claim 1 further comprising assigning a budget type of the tiered campaign.

7. The computer-implemented method of claim 1, wherein the viewing window is a web browser, or an application on a mobile device and the plurality of advertisements is served in a panel of the web browser or the application window of the mobile device.

8. The computer-implemented method of claim 7, wherein the panel comprises microsites, mobile applications, web applications, and banners.

9. The computer-implemented method of claim 7, wherein the panel is divided into the one or more sections.

10. The computer-implemented method of claim 7, wherein the panel is inserted into the HTML of a web page as a snippet code.

11. A non-transitory computer readable medium having stored thereon a plurality of instructions, sand plurality of instructions when executed by a computer, cause said computer to perform:
creating a tiered campaign containing a plurality of advertisements in one or more sections of a viewing window;
assigning a priority and preferences to each of the plurality of advertisements; and
serving the plurality of advertisements based on the assigned preferences and priorities.

12. The non-transitory computer readable medium of claim 11, wherein the priority comprises a display priority and exposure priority.

13. The non-transitory computer readable medium of claim 12, wherein the display priority comprises House priority, Network priority, Internal priority, and external priority.

14. The non-transitory computer readable medium of claim 13, wherein the plurality of advertisements are served in the order of House priority, Network priority, Internal priority, and external priority.

15. The non-transitory computer readable medium of 11, wherein the plurality of instructions cause the computer to further perform assigning a campaign type to the tiered campaign.

16. The non-transitory computer readable medium of 11, wherein the plurality of instructions cause the computer to further perform assigning a budget type of the tiered campaign.

17. The non-transitory computer readable medium of 11, wherein the viewing window is a web browser, or an application on a mobile device and the plurality of advertisements is served in a panel of the web browser or the application on the mobile device.

18. The non-transitory computer readable medium of 17, wherein the panel comprises microsites, mobile applications, web applications, and banners.

19. The non-transitory computer readable medium of 17, wherein the panel is divided into the one or more sections.

20. The non-transitory computer readable medium of 17, wherein the panel is inserted into the HTML of a web page as a snippet code.
